(19) United States
(12) Patent Application Publication
(10) Pub. No.: US 2024/0407603 A1
(43) Pub. Date: Dec. 12, 2024

(54) COFFEE GRINDER

(71) Applicant: WHIRLPOOL CORPORATION, BENTON HARBOR, MI (US)

(72) Inventors: Jiangang Guo, Foshan (CN); Edward Haney, Benton Harbor, MI (US); Pravin R. Shewale, Pune (IN); Michael P. Conti, Benton Harbor, MI (US); Shaozhen Zhang, Foshan (CN); Jinru Lin, Foshan (CN)

(73) Assignee: WHIRLPOOL CORPORATION, BENTON HARBOR, MI (US)

(21) Appl. No.: 18/694,725

(22) PCT Filed: Sep. 23, 2021
(86) PCT No.: PCT/CN2021/119963

§ 371 Date: Mar. 22, 2024

(51) Int. Cl. A47J 42/16; A47J 31/42; A47J 42/18; A47J 42/40; A47J 42/50

(52) U.S. Cl. CPC A47J 42/16; A47J 31/42; A47J 42/18; A47J 42/40; A47J 42/50

(57) ABSTRACT

A grinder appliance includes a body having a housing portion. A grinding assembly is positioned within the housing portion where the grinding assembly is configured to grind whole beans into ground beans. A chute extends between the grinding assembly and a discharge aperture. An ion generator extends through the chute and into a channel defined by the chute. The ion generator includes an attachment feature configured to be coupled to at least one of the body and the chute. At least one pin extends from an end of the attachment feature and into the channel. A power source is coupled to the at least one pin to generate an ion field within the channel to reduce a charge on the ground beans traveling through the chute.

### BACKGROUND OF THE DISCLOSURE

The present disclosure generally relates to a grinding assembly, and more specifically, to a countertop appliance with a grinding assembly.

### SUMMARY OF THE DISCLOSURE

According to one aspect of the present disclosure, a grinder includes a body having an interior. A hopper is coupled to the body. A grinding assembly is disposed within the interior of the body. The hopper has an opening for selectively adding a food substance to the grinding assembly. The grinding assembly includes a taper blade, a blade disc positioned about the taper blade, and a scraper plate operably coupled with the taper blade. A support plate is disposed adjacent to the scraper plate where the support plate has a discharge opening. A motor assembly is operably coupled to the taper blade to grind the food substance and the scraper plate to move a charged ground food substance. A chute is disposed within the interior of the body. The chute extends between the support plate and a discharge aperture of the body. The chute defines a channel that couples the discharge opening with the discharge aperture. An ion generator is disposed within the interior of the body. The ion generator includes pins disposed at least partially in the channel and a power source electrically coupled to the pins where a voltage is provided to the pins to generate a negative ion field within the channel and, consequently, reduce a charge on the charged grounds.

According to another aspect of the present disclosure, a grinder appliance includes a body having a housing portion. A grinding assembly is positioned within the housing portion. The grinding assembly is configured to grind whole beans into ground beans. A chute extends between the grinding assembly and a discharge aperture. An ion generator extends through the chute and into a channel defined by the chute. The ion generator includes an attachment feature configured to be coupled to at least one of the body and the chute. At least one pin extends from an end of the attachment feature and into the channel. A power source is coupled to the at least one pin to generate an ion field within the channel to reduce a charge on the ground beans traveling through the chute.

According to yet another aspect of the present disclosure, a countertop appliance includes a body that has a housing portion defining a discharge aperture and a dispensing opening. A hopper is coupled to the housing portion. A grinder is at least partially disposed within the housing portion where the grinder is aligned with the discharge opening of the housing portion. The grinder includes a grinding assembly. A chute that extends between the grinding assembly and the discharge aperture. An ion generator extends partially into a channel defined by the chute and is configured to generate an ion field within the channel. Charged grounds are discharged from the grinding assembly and non-charged particles are discharged from the grinder. A brew system is disposed at least partially in the housing portion and aligned with the dispensing opening.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a grinder with a porta-cup receptacle, according to the present disclosure;

FIG. 2 is a side perspective view of a grinder with a porta-filter receptacle, according to the present disclosure;

FIG. 3 is a top perspective view of a receptacle holder having two receiving levels for a porta-filter receptacle, according to the present disclosure;

FIG. 4 is a partial exploded side perspective view of a grinder, according to the present disclosure;

FIG. 5 is a cross-sectional view of the grinder of FIG. 1 taken along line IV-IV, according to the present disclosure;

FIG. 6 is a partial cross-sectional view of the grinder of FIG. 1 taken along line V-V, according to the present disclosure;

FIG. 7 is a side perspective exploded view of a grinding assembly and a motor assembly for a grinder, according to the present disclosure;

FIG. 8 is a cross-sectional view of a grinding assembly and a motor assembly for a grinder, according to the present disclosure;

FIG. 9 is a top perspective cross-sectional view of the grinder of FIG. 1 taken along lines VIII-VIII, according to the present disclosure;

FIG. 10 is a top perspective cross-sectional view of a grinder with an ion generator, according to the present disclosure;

FIG. 11 is a side perspective view of an ion generator with an ion generation feature, according to the present disclosure;

FIG. 12 is a side perspective view of an ion generator with pins extending from an attachment feature, according to the present disclosure;

FIG. 13 is a block diagram of a control system for a grinder, according to the present disclosure;

FIG. 14 is a partial cross-sectional view of a grinder illustrating a grinding process, according to the present disclosure; and

FIG. 15 is a schematic front elevational view of a countertop appliance having a grinder and a brew system, according to the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a grinding assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

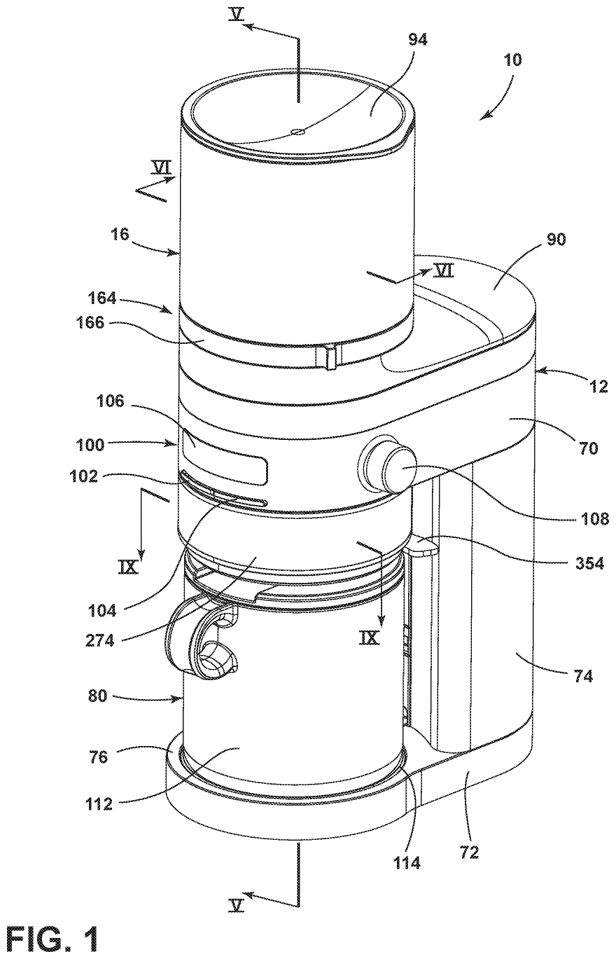

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

With reference to FIGS. 1-15 reference numeral 10 generally designates a grinder 10 that includes a body 12 having an interior 14. A hopper 16 is coupled to the body 12. A grinding assembly 18 is disposed within the interior 14 of the housing. The hopper 16 has a bean release opening 20 for selectively adding a food substance 22 to the grinding assembly 18. The grinding assembly 18 includes a taper blade 24, a blade disc 26 positioned about the taper blade 24, and a scraper plate 28 operably coupled with the taper blade 24. A support plate 30 is disposed adjacent to the scraper plate 28. The support plate 30 defines a grounds discharge opening 32. A motor assembly 34 is operably coupled to the grinding assembly 18. The motor assembly 34 drives the taper blade 24 to grind the food substance 22. A chute 36 is disposed within the interior 14 of the body 12. The chute 36 extends between the support plate 30 and a particle discharge aperture 38 defined by the body 12. The chute 36 defines a channel 40 that couples the grounds discharge opening 32 with the particle dispensing opening 38. An ion generator 42 is disposed at least partially within the interior 14 of the body 12. The ion generator 42 includes pins 44 disposed at least partially within the channel 40 and a power source 46 electrically coupled with the pins 44 to generate a negative ion field within the channel 40.

The grinder 10 is utilized to grind whole beans 60 (e.g., the food substance 22) into charged grounds 62 (e.g., ground beans) and then discharge non-charged particles 64. Typically, the grounds 62 are charged when static electricity is produced by the interaction between the grinding assembly 18 and the whole beans 60. In certain aspects where the whole beans 60 are coffee beans, the charged grounds 62 may be or include coffee chaff, which often scatters during a grinding process. The grinder 10 includes the ion generator 42 to reduce the charge on the grounds 62 to dispense the non-charged particles 64 to be used by a user. Accordingly, the grinder 10 produces the non-charged particles 64 that the user can use with a separate appliance, such as a countertop appliance, or for storing for later use. The ion generator 42 reducing the charge to produce the non-charged particles 64 may be advantageous for reducing scattering or clinging that is often produced by the charged grounds 62.

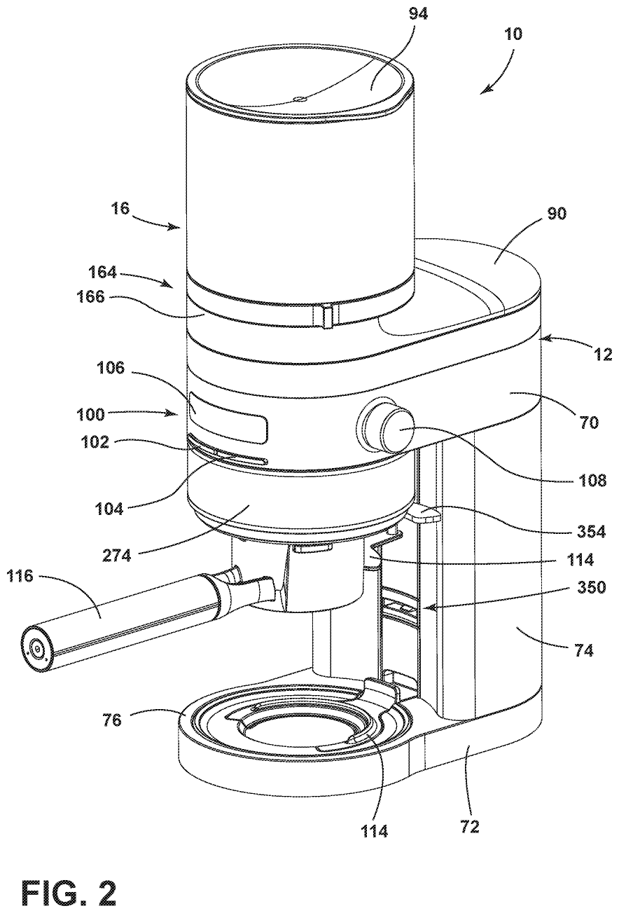

Referring to FIGS. 1 and 2, the grinder 10 is illustrated as a standalone appliance, which may be a countertop appliance. The grinder 10 includes the body 12 having a housing portion 70 coupled with the base 72 via a support structure 74. Generally, the housing potion is an upper portion of the body 12 and extends from a first, upper end of the support structure 74. The base 72 extends from a second, lower end of the support structure 74. The housing portion 70 and the base 72 extend generally horizontally from the support structure 74. The housing portion 70 is spaced from the base 72 to define a receiving space 76 for receiving a receptacle 80.

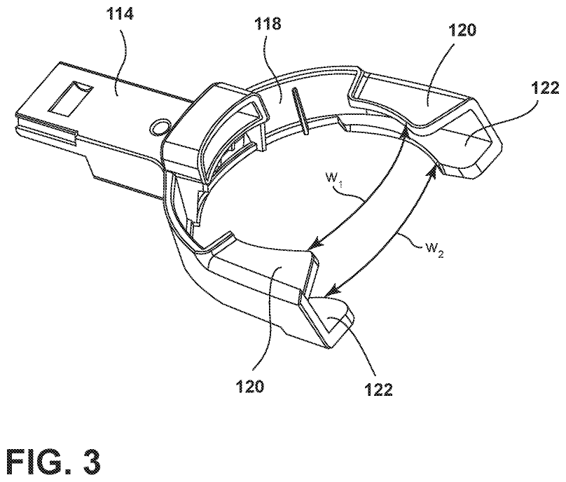

The housing portion 70 has an upper cover 90 that partially encloses the interior 14 of the housing portion 70. The upper cover 90 defines a receiving opening 92 (see FIG. 3) for selectively receiving the hopper 16. The hopper 16 extends vertically from the upper cover 90. The hopper 16 includes a lid 94, which is selectively removable to fill the hopper 16 with the food substance 22. Typically, the food substance 22 is a whole grain, the whole bean, such as a coffee bean, or other similar food substances 22 to be ground by the grinder 10.

Referring still to FIGS. 1 and 2, the grinder 10 includes a user interface 100, which is illustrated on a front 290 and a side of the housing portion 70. The user interface 100 includes selectable features 102, 104 and a display 106. A user may press, touch, or otherwise engage the selectable features 102, 104 to activate and/or deactivate the grinder 10. Additionally, the display 106 may be utilized to communicate information, such as the status of a grinding process, selected ground size, etc. The user interface 100 also includes a rotatable knob 108 on a side of the grinder 10. The knob 108 may be rotated by the user to select a type or size of the receptacle 80. The selected type or size may be utilized to determine a quantity of the grounds 62 or the serving size (e.g., single serving, multi-serving, etc.) to be produced.

In the example illustrated in FIG. 1, the receptacle 80 is configured as a porta-cup 112. The porta-cup 112 is positioned on a receptacle support 114 that extends along the base 72. The porta-cup 112 substantially fills the receiving space 76 of the grinder 10. The porta-cup 112 may be used for multi-serving portions or servings of the grounds 62, for storage, or a combination thereof. In certain examples, the porta-cup 112 may hold grounds 62 from a standard-sized package of whole beans 60. In the example illustrated in FIG. 2, the receptacle 80 is configured as a porta-filter 116. The porta-filter 116 may be utilized for a single serving or portion of the grounds 62. The porta-filter 116 may be supported by a second receptacle support 114, which is disposed proximate to the housing portion 70, or coupled to the housing portion 70 directly. Generally, the grinder 10 includes multiple receptacle supports 114 to interchangeably utilize different types of receptacles 80. Additionally or alternatively, the various receptacle supports 114 may be selectively coupled and removed to the support structure 74.

Referring to FIG. 3, the receptacle support 114 may be selectively coupled to the grinder 10. In various aspects, the receptacle support 114 may hold porta-filters 116 of different sizes. The receptacle support 114 includes a U-shaped support feature 118 defining a space to receive the porta-filter 116. The support feature 118 includes opposing upper flanges 120 and opposing lower flanges 122. One upper flange 120 and one lower flange 122 are positioned on each end of the U-shaped support feature 118 and are horizontally aligned with one another. Additionally, the upper flanges 120 are arranged vertically over the lower flanges 122.

The upper flanges 120 extend a first distance into the space to define a first width w₁ therebetween. The lower flanges 122 extend a second, lesser distance into the space to define a second width w₂ therebetween. The second width w₂ is less than the width w₁ to accommodate and support larger porta-filters 116. This configuration may be advantageous for using different sizes of porta-filters 116 with the grinder 10. The upper flanges 120 define a first receiving position or level to receive a first size of porta-filters 116 and the lower flanges 122 define a second receiving position or level to receive a second, large size of porta-filters 116. Accordingly, a porta-filter 116 having a first, smaller diameter may be supported at the first receiving position and a porta-filter having a second, greater diameter may be supported at the second receiving position.

The porta-filter 116 and the receptacle holder 114 may define mating or interlocking structures to support the porta-filter 116 on the receptacle holder 114. Additionally or alternatively, the upper flanges 120 and/or the lower flanges 120 may define grooves for receiving a projection of the porta-filter 116. The receptacle holder 114 may include any practicable features for holding porta-filters 116 of different sizes at the first receiving position and the second receiving position, respectively.

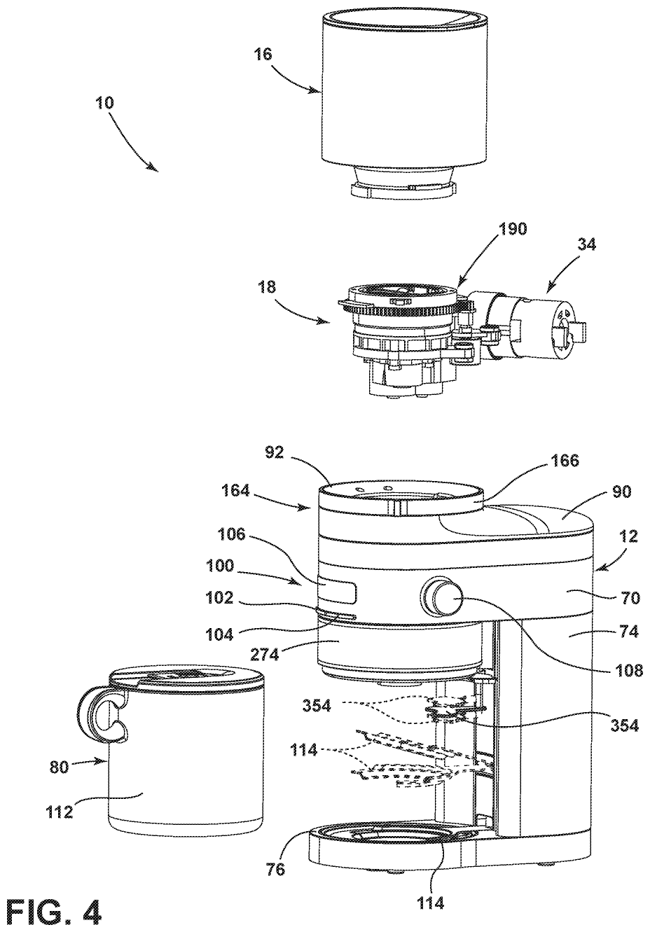

Referring to FIG. 4, the grinder 10 includes the hopper 16, which feeds the whole beans 60 (e.g., the food substance 22) into the grinding assembly 18. The grinding assembly 18 operates to grind the whole beans 60 into the grounds 62. Typically, during a grinding process, the grounds 62 become positively charged in response to the interaction between the whole beans 60 against metal components of the grinding assembly 18 produces an electrical charge. This electrical charge is generally a positive charge, but may be a negative charge or both without departing from the teachings herein.

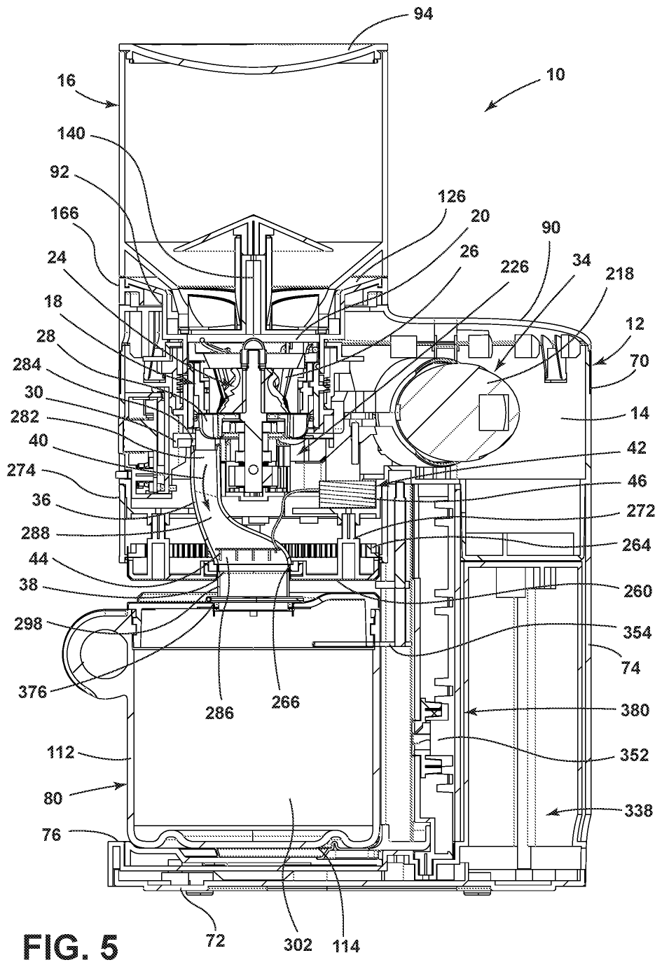

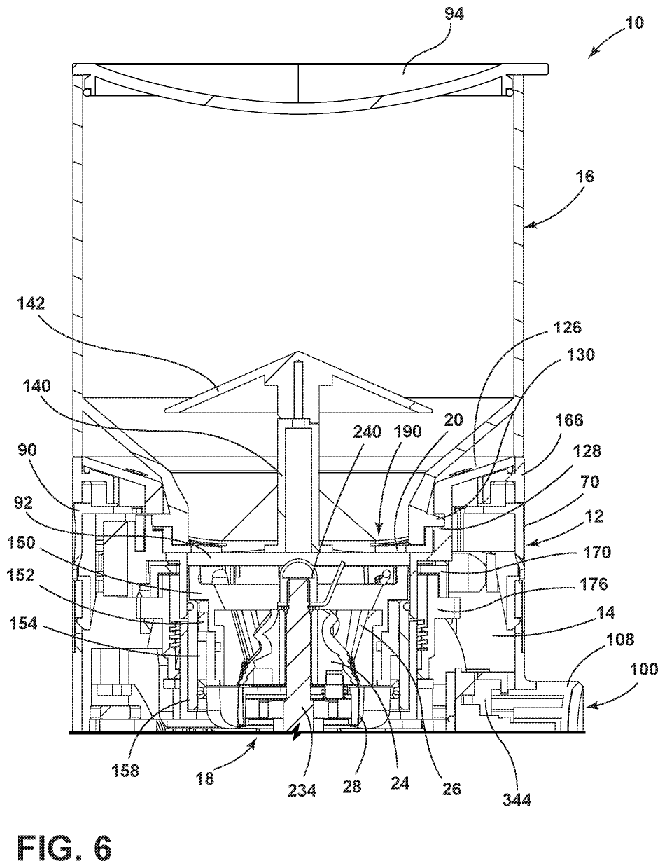

Referring still to FIG. 4, as well as to FIGS. 5 and 6, the housing portion 70 includes multiple components that enclose the interior 14 thereof. The upper cover 90 extends over the interior 14 and defines the receiving opening 92 to selectively receive the hopper 16. A funnel wall 126 is disposed within the receiving opening 92 and operates to narrow the receiving opening 92, as well as to support the hopper 16. The funnel wall 126 includes a groove 128, which engages a flange 130 on the hopper 16 to couple the hopper 16 to the body 12.

The hopper 16 includes a moving grate 140 coupled with a cover 142. The moving grate 140 is configured to rotate to selectively open and close the hopper 16 to dispense the whole beans 60. The moving grate 140 may be closed to prevent the whole beans 60 from being dispensed into the grinding assembly 18, as well as to close the hopper 16 to remove the hopper 16 from the body 12 and prevent spilling of the whole beans 60.

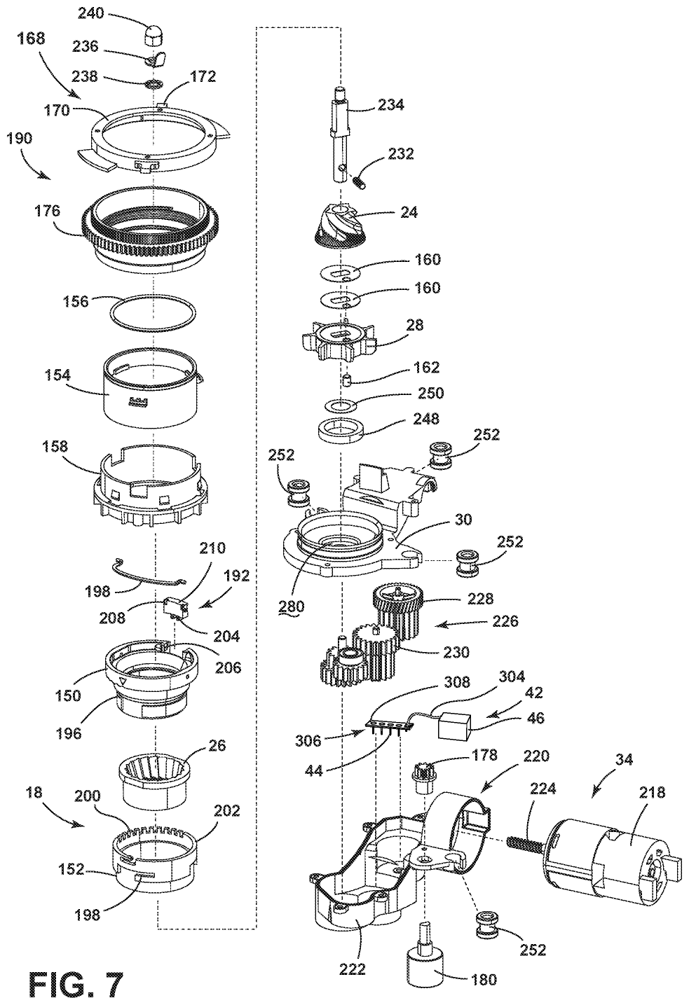

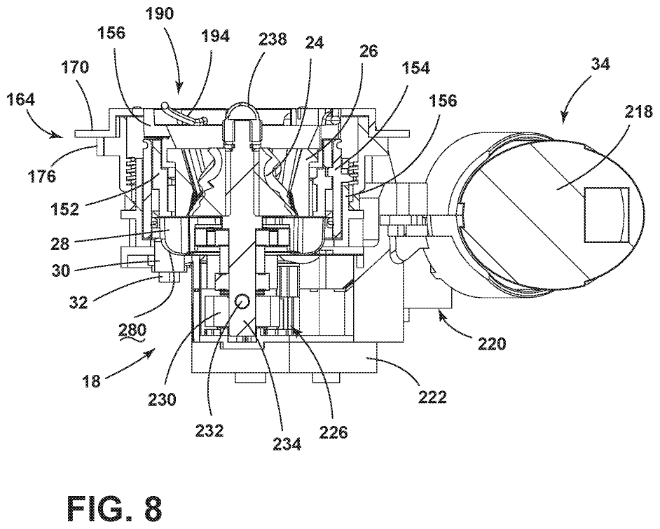

Referring still to FIG. 5, as well as to FIGS. 7 and 8, the grinding assembly 18 is disposed within the housing portion 70 and produces the charged grounds 62 from the whole beans 60. The grinding assembly 18 is illustrated as a burr grinding assembly 18; however, other configurations of the grinding assembly 18 may be utilized without departing from the teachings herein.

In the illustrated example, the grinding assembly 18 includes the taper blade 24 and the blade disc 26, which form the two grinding components of the burr grinder 10. The taper blade 24 generally has a wider lower end compared to an upper opposing end, thereby forming a conical or frusto-conical shape.

The blade disc 26 is disposed around the taper blade 24. A space between the blade disc 26 and the taper blade 24 is adjustable and determines a size of the grounds 62 to be produced, as described further herein. The blade disc 26 has a conical or frusto-conical shape, with an upper end of a central space of the blade disc 26 being wider than a lower end.

The blade disc 26 is supported by a disc bracket 150. The disc bracket 150 is generally cylindrical, and the blade disc 26 is located along an inner surface of the disc bracket 150. The taper blade 24 is disposed within the central space of the blade disc 26. The taper blade 24 is configured to rotate relative to the blade disc 26, causing the whole beans 60 to be ground.

The disc bracket 150 is disposed within an adjusting ring 152. The adjusting ring 152 and the disc bracket 150 are configured to rotatably engage one another to adjust the size of the grounds 62, as described further herein. The adjusting ring 152 is selectively disposed within a grinding bracket 154. A gasket 156 is disposed around the adjusting ring 152 and provides a seal between the adjusting ring 152 and the grinding bracket 154. The grinding bracket 154 is generally an annular bracket that fits about the adjusting ring 152. The grinding bracket 154 may provide a space for the adjusting ring 152 to rotate within the body 12.

The grinding bracket 154 is coupled with a fixing bracket 158. The fixing bracket 158 has an annular portion that extends about the grinding bracket 154. The fixing bracket 158 is configured to couple the disc bracket 150, the adjusting ring 152, and the grinding bracket 154 to the support plate 30.

The grinding assembly 18 also includes the scraper plate 28 disposed below the taper blade 24. The scraper plate 28 is configured to rotate with the taper blade 24 to move the grounds 62. Washers 160 are disposed between the taper blade 24 and the scraper plate 28. Additionally, a pin 162 extends through the scraper plate 28 and the washers 160 to retain the position of the washers 160 relative to the scraper plate 28 as the scraper plate 28 rotates.

Referring still to FIGS. 5, 7, and 8, the grinding assembly 18 may be adjusted to produce different sized grounds 62. There may be more than one method for adjusting the grinding assembly 18. In certain aspects, the grinding assembly 18 may be adjusted via a coarse adjustment assembly 164 while positioned inside of the housing portion 70. The grinder 10 includes an outer adjustment ring 166 that generally extends between the upper cover 90 and the hopper 16. The outer adjustment ring 166 may be manually adjusted by the user. The outer adjustment ring 166 is operably coupled to an inner adjustment assembly 168 disposed about the blade disc 26 within the housing portion 70.

The inner adjustment assembly 168 includes a ring cover 170 having radial projections 172. The outer adjustment ring 166 includes engagement features that extend inside the housing portion 70 to engage the radial projections 172. When the user rotates the outer adjustment ring 166, the interaction between the engagement features and the radial projections 172 causes the ring cover 170 to rotate. The ring cover 170 is operably coupled to a gear wheel 176. As the ring cover 170 is rotated, the gear wheel 176 is also rotated.

The ring cover 170 and/or the gear wheel 176 may adjust components of the grinding assembly 18 to adjust the size of the grounds 62 produced. For example, the ring cover 170 and/or the gear wheel 176 may adjust the position of the taper blade 28 as described further herein.

The gear wheel 176 is operably coupled to a mating gear 178. The mating gear 178 is disposed over the support plate 30 and engages the gear wheel 176. As the gear wheel 176 rotates, the mating gear 178 is also rotated. The mating gear 178 is operably coupled with a potentiometer 180. The potentiometer 180 is coupled to the support plate 30 and monitors a position of the mating gear 178, which generally corresponds with the position of the gear wheel 176 and, consequently, as the size of the grounds 62 to be produced by the grinding assembly 18. It is contemplated that the outer adjustment ring 166 may be utilized for rough adjustments of the size of the grounds 62.

In another example, the grinding assembly 18 may have a fine adjustment assembly 190 that may provide more specific sizes and/or may produce finer grounds 62 than the adjustments from the outer adjustment ring 166. This adjustment method is configured to adjust a position of the blade disc 26 relative to the taper blade 24 and, consequently, adjust a size of the grounds 62 that the grinding assembly 18 produces. The fine adjustment assembly 190 generally includes the blade disc 26, the disc bracket 150, the adjusting ring 152, and a limiting feature 192. The fine adjusting assembly may be selectively removed from the interior 14 of the housing when the hopper 16 (FIG. 1) is removed. In this way, the fine adjustments are generally manually made when the components are positioned outside of the housing portion 70. A handle 194 is rotatably coupled to the disc bracket 150 that surrounds the blade disc 26 to allow the user to remove the selected components.

The adjusting ring 152 is disposed around and rotatably engages the disc bracket 150. In various examples, the disc bracket 150 includes a first engagement feature 196, and the adjusting ring 152 includes a second, mating engagement feature 198. Each of the first and second engagement features 196, 198 may be, for example, sloped ramps, helical ramps, sloped grooves, helical grooves, or a combination thereof. The mating engagement features 196, 198 allow rotation of the adjustment ring relative to the disc bracket 150.

The rotation of the adjusting ring 152 changes a position of the blade disc 26 relative to the disc bracket 150. Generally, the blade disc 26 is moved between an upper opening and a lower opening of the disc bracket 150. The change in position relative to the disc bracket 150 also adjusts the position of the blade disc 26 relative to the taper blade 24 when the blade disc 26 is installed in the grinding assembly 18. When the adjusting ring 152 is rotated in a first direction (e.g., clockwise), the blade disc 26 is adjusted so a bottom of the blade disc 26 is flush with the taper blade 24, thereby producing finer grounds 62. When the adjusting ring 152 is rotated in a second direction (e.g., counterclockwise), the bottom of the blade disc 26 is offset from the taper blade 24, thereby producing coarser grounds 62.

The disc bracket 150 includes the limiting feature 192, which cooperates with the adjusting ring 152. The limiting feature 192 operates to limit or prevent movement in a select direction beyond a certain amount of rotation relative to the disc bracket 150. In this way, the finest and/or coarsest size produced by the fine adjustment assembly 190 is defined by the limiting feature 192.

The limiting feature 192 also operates to lock the adjusting ring 152 in a selected position. The adjusting ring 152 includes a plurality of 200 along an upper edge 202 thereof. The limiting feature 192 defines teeth 204 that are configured to mesh or interlock with the teeth 200 of the adjusting ring 152. The limiting feature 192 is operable between a release position and a lock position. In the release position, the teeth 204 disengage with the teeth 200 of the adjusting ring 152, allowing the adjusting ring 152 to rotate. When in the lock position, the teeth 204 are engaged with the teeth 200 of the adjusting ring 152, preventing rotation and locking the adjusting ring 152 in the selected position.

In various examples, the disc bracket 150 defines a notch 206 and the limiting feature 192 is disposed within the notch 206. The limiting feature 192 includes a pin 208 and a baffle 210. The pin 208 extends across the notch 206 and is coupled to the disc bracket 150 at each end. The baffle 210 is coupled to the pin 208 and is configured to rotate between the release position and the lock position.

The user may remove the fine adjustment assembly 190 from the body 12. The user may then rotate the baffle 210 to the release position. The user rotates the adjusting ring 152 relative to the disc bracket 150 to the selected position that corresponds to a selected size of the grounds 62 to be produced. Once the adjusting ring 152 is in the selected position, the baffle 210 is rotated to the lock position, interlocking the teeth 204 of the baffle 210 with the teeth 200 of the adjusting ring 152. The fine adjustment assembly 190 may then be placed within the grinding assembly 18. In certain aspects, the coarse adjustment assembly 164 may slightly adjust the grinding assembly 18, while the fine adjustment assembly 190 further adjusts the grinding assembly 190 for more precise or finer grounds 62.

The grinding assembly 18 also includes the scraper plate 28 disposed below the taper blade 24. The scraper plate 28 may be configured to rotate with the taper blade 24. The scraper plate 28 is configured to move the grounds 62 produced by the taper blade 24 and the blade disc 26 to be discharged from the grinding assembly 18.

Referring still to FIGS. 5, 7, and 8, the grinding assembly 18 is operably coupled with the motor assembly 34, which is also disposed within the interior 14 of the housing portion 70. The motor assembly 34 includes a motor 218 and a gearbox 220. In various examples, the support plate 30 forms a top of the gearbox 220 and is coupled with a bottom 222 of the gearbox 220. The motor 218 is operably coupled with a worm gear 224 that extends into the gearbox 220.

The gearbox 220 houses a plurality of gears 226 that is configured to couple the motor 218 with the taper blade 24. The worm gear 224 engages a first gear 228 of the plurality of gears 226, which transfers a drive motion from the worm gear 224 through the plurality of gears 226 to a final gear 230. The final gear 230 engages a pin 232 that extends through a shaft 234. The shaft 234 extends through the scraper plate 28 and the taper blade 24. The shaft 234 extends through the taper blade 24 and engages two washers 236, 238 and a cap nut 240, which operate to retain the taper blade 24 on the shaft 234. It is also contemplated that the motor assembly 34 may additionally or alternatively drive rotation of the blade disc 28.

As the final gear 230 is rotated, the pin 232 and the shaft 234 are rotated, which consequently rotate the taper blade 24 and the scraper plate 28. Accordingly, the taper blade 24 is driven by the motor assembly 34 to grind the whole beans 60. Additionally or alternatively, a support ring 248 may be disposed on the support plate 30 between the support plate 30 and the scraper plate 28. The support ring 248 and a washer 250 may assist the scraper plate 28 in rotating relative to the support plate 30 with minimal or no interference in the rotation.

In various examples, the grinder 10 includes shock-absorbing features 252. The shock-absorbing features 252 are coupled to the gearbox 220 and configured to absorb movement of the motor assembly 34 and/or the gearbox 220 to reduce noise caused by the grinder 10.

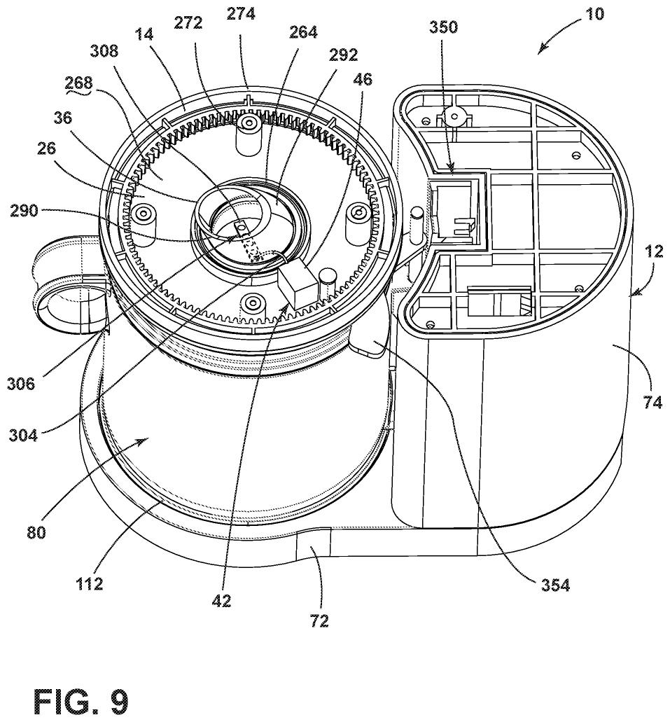

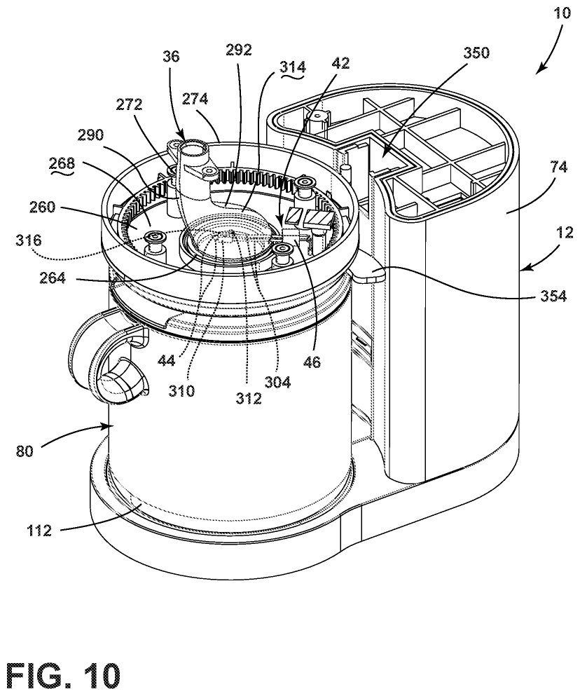

With reference still to FIG. 5, as well as to FIGS. 9 and 10, the housing portion 70 includes a bottom cover plate 260, disposed below the grinding assembly 18 and adjacent to the receiving space 76. The bottom cover plate 260 defines the particle dispensing aperture 38 for discharging the particles 64 into the receptacle 80. A retaining ring 264 having a groove 266 is coupled to an inner surface 268 of the bottom cover plate 260 and extends around the discharge aperture 38. The retaining ring 264 assists in locating the chute 36 relative to the grounds discharge opening 32 and the particle discharge aperture 38.

The bottom cover plate 260 includes extension supports 272 for coupling the bottom cover plate 260 to other support components within the housing portion 70. Additionally or alternatively, the housing portion 70 may also include an additional outer adjustment ring 274 166, which may adjust a position of the bottom cover plate 260.

Referring still to FIGS. 5, 9, and 10, the support plate 30 is disposed at least partially below the grinding assembly 18. Generally, the support plate 30 extends around the shaft 234 and directly below the scraper plate 28. As the whole beans 60 are ground, the charged grounds 62 are deposited on a surface 280 of the support plate 30. The scraper plate 28 is rotated by the shaft 234 and pushes the grounds 62 through the discharge opening 32 defined in the support plate 30. The support plate 30 is configured to collect the grounds 62 produced by the grinding assembly 18, and the scraper plate 28 is configured to move the grounds 62 along the surface 280 of the support plate 30 and through the discharge aperture 38.

The chute 36 extends through the housing portion 70 between the support plate 30 and the retaining ring 264. Generally, a receiving end 282 of the chute 36 has two flanges 284, which are fastened to a bottom of the support plate 30. The receiving end 282 of the chute 36 aligns with the discharge opening 32. A dispensing end 286 of the chute 36 is disposed within the groove 266 of the retaining ring 264. The groove 266 operates to retain the chute 36 in the selected position relative to the discharge aperture 38 of the bottom cover plate 260.

The chute 36 operates to guide the grounds 62 along a discharge path 288 from the grinding assembly 18 to the receptacle 80. The receiving end 282 of the chute 36 is offset from the discharge end of the chute 36 such that the grounds 62 travel vertically and horizontally when moving through the channel 40 defined by the chute 36. The chute 36 defines an asymmetric shape, which assists in guiding the grounds 62 to the receptacle 80. A front 290 of the chute 36 has a shallow curvature between the receiving end 282 and the discharge end 286. A rear 292 of the chute 36 has a generally sinusoidal shape with a first curve 294 in a first direction and a second curve 296 in a second opposing direction. The first and second curves 294, 296 are generally greater or sharper curves than the shallow curve at the front 290 of the chute 36.

The curves 294, 296 of the chute 36 widen then channel 40 defined by the chute 36. A width of the receiving end 282 is less than the width of the discharge end 286. The chute 36 extends around an entirety of the discharge opening 32 defined in the support plate 30 and an entirety of the discharge aperture 38 defined by the bottom cover plate 260.

A guide feature 298 may be selectively coupled to the bottom cover plate 260. The guide feature 298 extends from the bottom cover plate 260 into the receiving space 76. The guide feature 298 may extend into or proximate to an interior 302 of the receptacle 80. The guide feature 298 provides an extension of the channel 40 defined by the chute 36 to guide the particles 64 into the receptacle 80. The guide feature 298 may be advantageous for when the receptacle 80 does not directly engage the bottom cover plate 260.

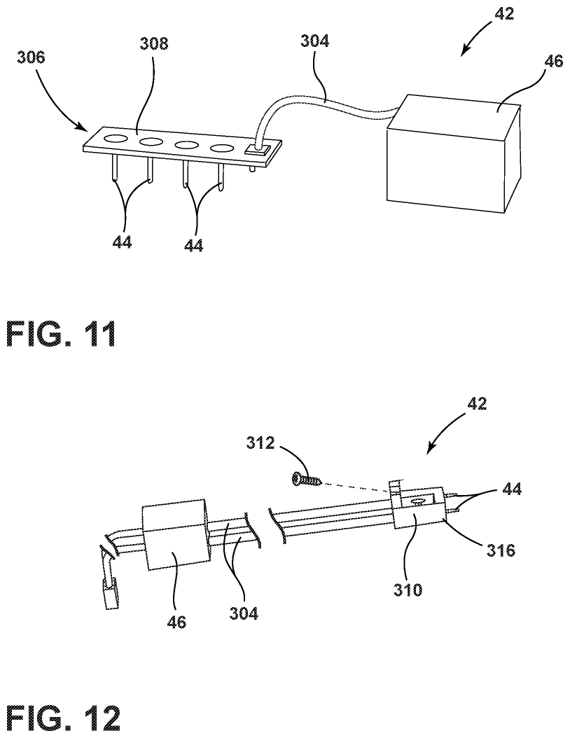

With reference still to FIGS. 9 and 10, as well as to FIGS. 11 and 12, the grinder 10 includes the ion generator 42 that at least partially extends into the channel 40 of the chute 36. In this way, the ion generator 42 extends into the discharge path 288 of the charged grounds 62 produced by the grinding assembly 18. The ion generator 42 includes the power source 46 in electrical communication with metal pins 44. A voltage is applied to the pins 44, causing a charge to be released into the channel 40.

As previously stated, the charged grounds 62 generally have a positive charge when being discharged from the grinding assembly 18. In such examples, the ion generator 42 releases a negative charge into the channel 40. The positively charged grounds 62 travel through the negative ion field when traveling along the discharge path 288. After moving through the negative ion field, the charge on the grounds 62 is reduced or eliminated such that the non-charged particles 64 are dispensed from the grinder 10.

As illustrated in FIGS. 9 and 11, the power source 46 is within the interior 14 of the housing portion 70. The power source 46 may be disposed on the bottom cover plate 260 (as illustrated in FIGS. 9 and 10), on an additional support structure 74 (as illustrated in FIG. 5), on the chute 36, elsewhere in the body 12, etc. An electrical connector 304 extends from the power source 46, through the chute 36, and to an ion generation feature 306 having the pins 44. The ion generation feature 306 includes a plate 308, with the pins 44 extending from the plate 308 in a single direction. As illustrated, the plate 308 extends across the channel 40 and the pins 44 extend vertically from the plate 308 toward the receiving space 76. The plate 308 may be coupled to an inside surface of the chute 36 to retain the ion generation feature 306 in a selected position. The plate 308 may extend across a substantial portion or an entirety of the channel 40, allowing the charge or ion field to be released across the channel 40.

In the illustrated example of FIGS. 9 and 11, the pins 44 extend vertically downward from the plate 308. It is also contemplated that the pins 44 may extend horizontally from the plate 308, which may be advantageous for reducing interface with the discharge path 288. It is also contemplated that the plate 308 may have apertures, allowing the grounds 62 to pass through the plate 308 along the discharge path 288.

An additional or alternative configuration of the ion generator 42 is illustrated in FIGS. 10 and 12. The ion generator 42 includes the power source 46 and an attachment feature 310. The pins 44 extend from a distal end 316 of the attachment feature 310. Multiple electrical connectors 304 extend between the pins 44 and the power source 46. In the illustrated example, two electrical connectors 304 extend between the power source 46 and the attachment feature 310 having the two pins 44. The attachment feature 310 may be coupled to various components or locations via a coupling member 312, depending on the configuration of the grinder 10. For example, the attachment feature 310 may be coupled to the bottom cover plate 260, an outside surface 314 of the chute 36, an inside surface of the chute 36, etc. In another example, the attachment feature 310 may be coupled to the chute 36 and extend at least partially through the chute 36. In an additional example, the attachment feature 310 may be disposed at least partially within the channel 40.

The pins 44 extend from the distal end 316 of the attachment feature 310 into the discharge path 288. In the illustrated example, the pins 44 are horizontally aligned with one another. The pins 44 may extend through the chute 36 and into the channel 40 or, in examples where the attachment feature 310 extends through the chute 36, the pins 44 may be entirely disposed within the channel 40. In the illustrated configuration of FIGS. 10 and 12, the pins 44 extend horizontally in the channel 40. The pins 44 also taper as the pins 44 extend further into the channel 40 (e.g., from a proximal end adjacent to the attachment feature 310 to a distal end), which may be advantageous not substantially impinging on the discharge path 288. Additional pins 44 may be utilized to release a larger charge without departing from the teachings herein.

Referring again to FIGS. 9-12, the ion generator 42 extends through the chute 36 proximate to the discharge aperture 38. The ion generator 42 produces the charge or ion field, which may be an opposing charge relative to the charged grounds 62. For example, the charged grounds 62 may be positively charged, and the ion generator 42 may release a negative ion field. The negative ion field from the ion generator 42 is released into the channel 40 and the charged grounds 62 pass through the negative ion field as the grounds 62 are traveling along the discharge path 288. The charge on the grounds 62 is then neutralized, or at least substantially neutralized, such that the non-charged particles 64 are dispensed through the discharge aperture 38 and into the receptacle 80. The charged grounds 62, without the ion generator 42, often cling to and/or scatter across surfaces within and surrounding the grinder 10. The use of the ion generator 42 reduces or eliminates the clinging and scattering of the grounds 62 by dispensing the non-charged particles 64.

In the illustrated examples, the ion generator 42 extends through the rear 292 of the chute 36. The shape of the rear 292 side of the chute 36 and the offset of the discharge aperture 38 provides a space that may be offset from the directly vertical discharge path 288. The ion generator 42 may then produce less interference with the discharge path 288 when extending into the channel 40 in this space. Further, the chute 36 may define a gap or hole for the ion generator 42 to extend through, and fewer grounds 62 may escape the chute 36 through a gap in the rear 292 of the chute 36. Generally, the ion generator 42 extends through the rear 292 of the chute 36 between the first curve 294 and the second curve 296 or adjacent to the second curve 296.

Further, the ion generator 42 extends through one of the widest or the widest areas of the channel 40, which also minimizes interference with the grounds 62. The wider portion of the channel 40 may allow more space for the charged grounds 62 to spread, allowing more grounds 62 to interact with the negative ion field.

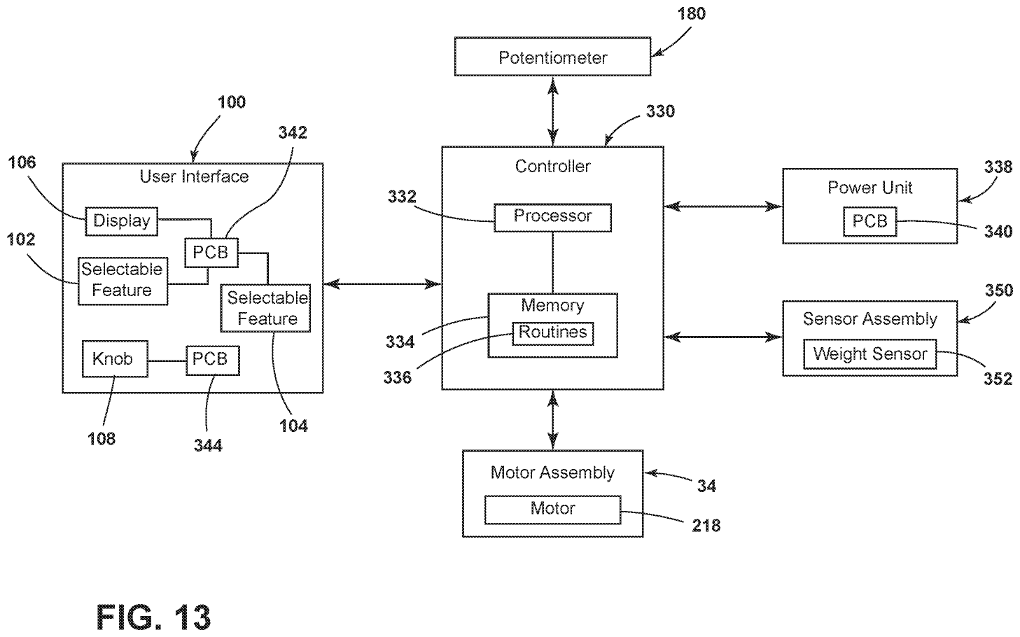

Referring to FIG. 13, as well as FIGS. 1-12, the grinder 10 includes a controller 330 having a processor 332, a memory 334, and other control circuitry. Instructions or routines 336 are stored within a memory 334 and executable by the processor 332. The controller 330 disclosed herein may include various types of control circuitry, digital or analog, and may include the processor 332, a microcontroller, an application specific circuit (ASIC), or other circuitry configured to perform the various input or output, control, analysis, or other functions described herein. The memory 334 described herein may be implemented in a variety of volatile and nonvolatile memory formats. The routines 336 include operating instructions to enable various functions described herein.

The controller 330 is in communication with a power unit 338, which is generally stored within the support structure 74. The power unit 338 generally includes a power circuit board or printed circuit board (PCB) 340. The controller 330 is also in communication with the user interface 100, which includes the display 106, the selectable features 102, 104, and the knob 108. The display 106 and the selectable features 102, 104 are coupled to a PCB 342 disposed adjacent to the display 106 but may be coupled with separate PCBs 342 without departing from the teachings herein. Further, the knob 108 is operably coupled with an additional PCB 344 disposed adjacent to the knob 108. In PCB examples, the PCBs may be a flexible PCB or a rigid PCB.

The grinder 10 may include a sensor assembly 350 having a sensor 352, such as a weight or force sensor 352, and a connector 354. The weight sensor 352 is disposed within the support structure 74 proximate to the receiving space 76. The connector or connectors 354 extend into the receiving space 76 to engage the receptacle 80. The sensor assembly 350 is generally configured to sense or weigh the particles 64 deposited in the receptacle 80. The connectors 354 that extend into the receiving space 76 may engage the receptacle 80 disposed in the receiving space 76 to monitor the weight thereof.

The controller 330 may store predefined receptacle weights for various receptacles 80. Further, the controller 330 may have at least one routine to monitor the weight of the particles 64 relative to predefined weights associated with selected serving sizes. The controller 330 may also store predefined weights that are indicative of a select amount of particles 64 for each receptacle 80. The grinding assembly 18 may cease grinding when the sensor assembly 350 senses the selected weight or serving size of the particles 64 has been received in the receptacle 80. The controller 330 is communicatively coupled with the motor assembly 34 and may operate to activate and deactivate the motor assembly 34 based on an input from the user interface 100, a signal from the sensor assembly 350, etc.

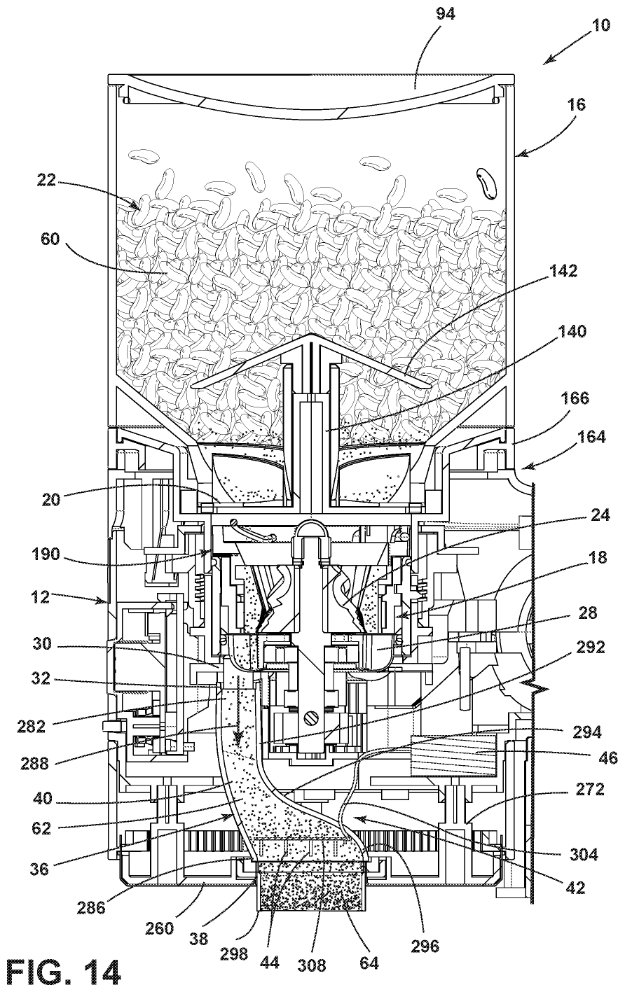

Referring to FIG. 14, as well as to FIGS. 1-13, in operation, a user inserts whole beans 60 or grains (e.g., the food substance 22) into the hopper 16. The user then places the lid 94 on the hopper 16. The user may rotate the adjusting ring 152 to the coarse adjustment assembly 164 to the selected size of the particles 64 to be produced. The controller 330 may monitor the position of the coarse adjustment assembly 164 using the potentiometer 180. The user may also remove the fine adjustment assembly 190 and rotate the adjusting ring 152 to move the blade disc 26 relative to the taper blade 24 and retain the adjusting ring 152 in the select position via the limiting feature 192. The user may then re-install the fine adjustment assembly 190 into the body 12. The user places the selected receptacle 80 on the corresponding receptacle support 114 and recouples the hopper 16 to the body 12. The user rotates the knob 108 to indicate the size of the receptacle 80. The user may then engage the user interface 100 to activate the grinder 10.

Upon receiving the input from the user interface 100, if the whole beans 60 have not yet been discharged to the grinding assembly 18, the whole beans 60 are deposited in the grinding assembly 18 by the hopper 16. The controller 330 then activates the motor assembly 34 to drive the taper blade 24 to grind the whole beans 60. The grounds 62 are deposited on the support plate 30 and then moved along the support plate 30 by the scraper plate 28.

Along with or prior to activation of the motor assembly 34, the controller 330 also activates the ion generator 42. The voltage is provided to the pins 44, causing the charge or ion field to be generated in and/or released into the discharge path 288 in the chute 36. Activating the ion generator 42 simultaneously with or prior to the motor assembly 34, causes the ion field to be generated in the channel 40 prior to the grounds 62 entering the chute 36. Accordingly, the amount of charged grounds 62 exiting the discharge aperture 38 is reduced or eliminated. The ion generator 42 may remain activated while the motor assembly 34 is active or until the receptacle 80 is removed from the grinder 10, as sensed by the sensor assembly 350.

As the grounds 62 travel through the chute 36, the grounds 62 travel through the ion field, neutralizing the charge and producing the non-charged particles 64. The non-charged particles 64 then continue through the chute 36 and through the discharge aperture 38. The non-charged particles 64 may travel through the guide feature 298 into the receptacle 80 or directly into the receptacle 80.

As the particles 64 are deposited in the receptacle 80, the weight on the connector 354 engaging the receptacle 80 changes. The weight is sensed by the sensor assembly 350 and monitored by the controller 330. The controller 330 may compare the sensed weight with the predefined weight for the selected serving size. The predefined weight may correspond with the type and size of the receptacle 80 used. Once the sensed weight matches the predefined weight, the controller 330 may deactivate the grinding assembly 18 to stop producing the particles 64. It is also contemplated that the controller 330 may deactivate the grinding assembly 18 at a weight slightly less than the total predefined weight for the selected serving size. In such examples, the grounds 62 in the chute 36 when the grinding assembly 18 is deactivated, may be deposited into the receptacle 80 after the motor assembly 34 is deactivated without overfilling the receptacle 80 relative to the predefined weight. The user may then remove the receptacle 80 from the grinder 10 for subsequent use or storage.

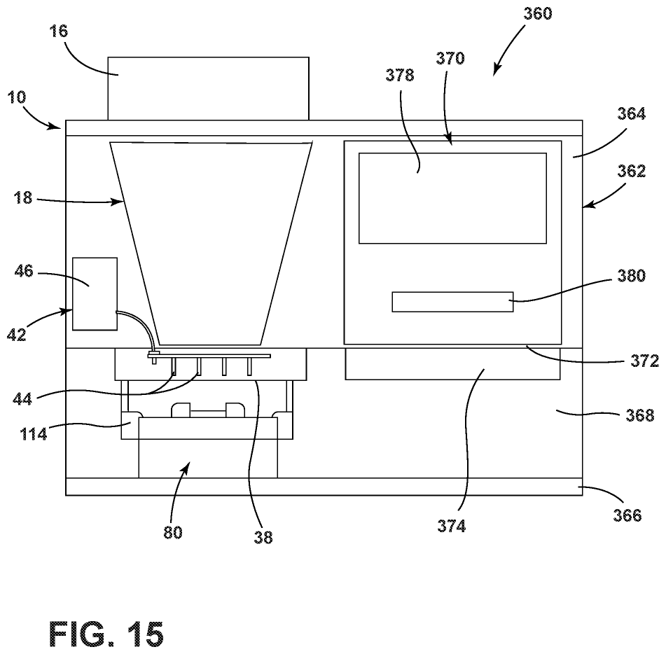

Referring to FIG. 15, as well as FIGS. 1-14, the grinder 10 or aspects thereof may be incorporated into a countertop appliance 360, such as a coffee maker or espresso machine. For example, the hopper 16, the grinding assembly 18, the adjustment assemblies 164, 190, the motor assembly 34, the ion generator 42, and/or the sensor assembly 450 may be incorporated into the countertop appliance 360. The receptacles 80 may also be used with the countertop appliance 360 to receive the selected serving size of the particles 64. These components operate in a similar manner as described herein such that the grinding assembly 18 operates to grind the whole beans 60, the grounds 62 are moved along the discharge path 288, through the chute 36, through the ion field generated by the ion generator 42, and the particles 64 are dispensed into the receptacle 80.

The countertop appliance 360 includes a body 362 having an upper housing portion 364, a base 366, and a support structure 368 extending therebetween. The hopper 16 is coupled to the upper housing portion 364 and may extend above a top surface of the upper housing portion 364. The grinding assembly 18, the fine adjustment assembly 190, and the ion generator 42 are disposed within the upper housing portion 364 and arranged in a similar configuration as described in the grinder 10. The ion generator 42 reduces or prevents the particles 64 from scattering and clinging to surfaces around the countertop appliance 360.

The countertop appliance 360 also includes a brew system 370 within the upper housing portion 364 and a dispensing opening 372 in fluid communication with the brew system 370. The countertop appliance 360 also includes a coupling feature 374 for coupling the receptacle 80 to the upper housing portion 364 adjacent to the dispensing opening 372.

In operation, the user may grind the whole beans 60 into the non-charged particles 64 using the countertop appliance 360 as described herein. If more particles 64 are produced and are to be stored for later use, the receptacle 80 may have a cap 376 that encloses the interior 302 of the receptacle 80. If the particles 64 are for immediate use, the user may then move the receptacle 80 from the receptacle support 114 associated with the grinding assembly 18 to the coupling feature 374 associated with the brew system 370. The user may then add water to a storage container 378 coupled with the body 12 or otherwise have water added to the countertop appliance 360. The water is included in or in fluid communication with the brew system 370. The brew system 370 also includes a heater 380 for heating the water.

The user may then input a type of final product, such as a type of beverage, into the user interface 100. The controller 330 may be in communication with the grinding and brewing aspects of the countertop appliance 360. In response to the user input, the controller 330 activates the brew system 370, which draws water from the storage container 378, heats the water, and dispenses water through the receptacle 80 and into a cup, bowl, or other containers. The amount of water may be determined based on the user input.

Use of the present device may provide for a variety of advantages. For example, the ion generator 42 may be disposed within the housing portion 70, 364 of the grinder 10 or the countertop appliance 360 and may not extend outside of the housing portion 70, 364, respectively. In this way, the ion generator 42 may be concealed from the user. Additionally, the ion generator 42 may be disposed proximate to the dispensing aperture 38 to reduce the scatter of the particles 64 being discharged. Further, the ion generator 42 may be positioned to not substantially impede the flow of the particles 64 along the discharge path 288 through the channel 40 of the chute 36. Also, the ion generator 42 may generate a negative ion field which reduces the positive charge of the grounds 62 and consequently reduces or prevents scattering or clinging of the non-charged particles 64.

Moreover, the grinding assembly 18 may include the coarse adjustment assembly 164 and/or the fine adjustment assembly 190. Further, different types and sizes of receptacles 80 may be utilized with the grinder 10 and the countertop appliance 360. Further, the grinder 10 may include the sensor assembly 350 configured to measure the weight of the receptacle 80 and/or the particles 64 disposed within the receptacle 80. Further, the grinder 10 may automatically cease grinding the whole beans 60 when the weight sensed by the sensor assembly 350 reaches the predefined weight. Further, the grinder 10 may be a standalone appliance or may be incorporated into the countertop appliance 360 having the brew system 370. Additional benefits or advantages may be realized and/or achieved.

The device disclosed herein is further summarized in the following paragraphs and is further characterized by combinations of any and all of the various aspects described therein.

According to another aspect of the present disclosure, a grinder includes a body having an interior. A hopper is coupled to the body. A grinding assembly is disposed within the interior of the body. The hopper has an opening for selectively adding a food substance to the grinding assembly. The grinding assembly includes a taper blade, a blade disc positioned about the taper blade, and a scraper plate operably coupled with the taper blade. A support plate is disposed adjacent to the scraper plate where the support plate has a discharge opening. A motor assembly is operably coupled to the taper blade to grind the food substance and the scraper plate to move a charged ground food substance. A chute is disposed within the interior of the body. The chute extends between the support plate and a discharge aperture of the body. The chute defines a channel that couples the discharge opening with the discharge aperture. An ion generator is disposed within the interior of the body. The ion generator includes pins disposed at least partially in the channel and a power source electrically coupled to the pins where a voltage is provided to the pins to generate a negative ion field within the channel and, consequently, reduce a charge on the charged grounds.

According to another aspect, pins taper from a proximal end to a distal end.

According to another aspect, pins extend into a channel adjacent to a discharge aperture.

According to another aspect, a receptacle support is selectively coupled to a body including upper flanges that define a first receiving level to receive a first porta-filter of a first size and lower flanges that define a second receiving level to receive a second porta-filter of a second size.

According to another aspect, an ion generator includes an electrical connector that extends through a chute to pins.

According to another aspect, a grinding assembly includes an adjustment assembly having an adjusting ring coupled to a disc bracket. The disc bracket is coupled to a blade disc. The adjusting ring is configured to rotate and adjust a position of the disc bracket and consequently the blade disc.

According to another aspect, an ion generator includes a plate having pins. The plate extends at least partially across a channel.

According to another aspect, a grinder appliance includes a body having a housing portion. A grinding assembly is positioned within the housing portion where the grinding assembly is configured to grind whole beans into ground beans. A chute extends between the grinding assembly and a discharge aperture. An ion generator extends through the chute and into a channel defined by the chute. The ion generator includes an attachment feature configured to be coupled to at least one of the body and the chute. At least one pin extends from an end of the attachment feature and into the channel. A power source is coupled to the at least one pin to generate an ion field within the channel to reduce a charge on the ground beans traveling through the chute.

According to another aspect, a width of a receiving end of a chute is greater than a width of a dispensing end of the chute.

According to another aspect, at least one pin extends into a channel proximate to the dispensing end of a chute.

According to another aspect, a receptacle is configured to receive ground beans from the discharge aperture of the grinding assembly.

According to another aspect, at least one pin includes a first pin spaced from a second pin.

According to another aspect, a first pin is horizontally aligned with a second pin.

According to another aspect, at least one pin has a proximal end having a width greater than a width of a distal end disposed within a channel.

According to another aspect, a front of a chute has a shallower curve than a rear of the chute. At least one pin extends through the rear of the chute.

According to another aspect, a countertop appliance includes a body that has a housing portion defining a discharge aperture and a dispensing opening. A hopper is coupled to the housing portion. A grinder is at least partially disposed within the housing portion where the grinder is aligned with the discharge aperture of the housing portion. The grinder includes a grinding assembly. A chute extends between the grinding assembly and the discharge aperture, and an ion generator extends partially into a channel defined by the chute and is configured to generate an ion field within the channel. Charged grounds are discharged from the grinding assembly and non-charged particles are discharged from the grinder. A brew system is disposed at least partially in the housing portion and aligned with the dispensing opening.

According to another aspect, a grinding assembly includes a blade disc and a taper blade. A space between the blade disc and the taper blade is adjustable to determine a size of charged grounds.

According to another aspect, an ion generator includes a plate with pins extending from the plate. The plate extends at least partially across a channel.

According to another aspect, an ion generator includes pins that extend vertically within a channel defined by the chute.

According to yet another aspect, a chute defines a first curve in a first direction and a second curve in a second direction. An ion generator extends through the chute between the first curve and the second curve.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1.-20. (canceled)

21. A grinder, comprising:
a body having an interior;
a hopper coupled to the body;
a grinding assembly disposed within the interior of the body, wherein the hopper has an opening for selectively adding a food substance to the grinding assembly, wherein the grinding assembly includes:
a taper blade;
a blade disc positioned about the taper blade; and
a scraper plate operably coupled with the taper blade;
a support plate disposed adjacent to the scraper plate, and wherein the support plate has a discharge opening;
a motor assembly operably coupled to the taper blade to grind the food substance into charged grounds, and wherein the motor assembly is operably coupled to the scraper plate to move the charged grounds;
a chute disposed within the interior of the body, wherein the chute extends between the support plate and a discharge aperture of the body, wherein the chute defines a channel that couples the discharge opening with the discharge aperture; and
an ion generator disposed within the interior of the body, wherein the ion generator includes pins disposed at least partially in the channel and a power source electrically coupled to the pins, and wherein a voltage is provided to the pins to generate a negative ion field within the channel and, consequently, reduce a charge on the charged grounds.

22. The grinder of claim 21, wherein the pins taper from a proximal end to a distal end.

23. The grinder of claim 21, wherein the pins extend into the channel adjacent to the discharge aperture.

24. The grinder of claim 21, further comprising:
a receptacle support selectively coupled to the body and including upper flanges and lower flanges, wherein the upper flanges define a first receiving level to receive a first porta-filter of a first size, and wherein the lower flanges define a second receiving level to receive a second porta-filter of a second size, the first size being different than the second size.

25. The grinder of claim 21, wherein the ion generator includes an electrical connector that extends through the chute to the pins.

26. The grinder of claim 21, wherein the grinding assembly includes:
a disc bracket coupled to the blade disc; and
an adjustment assembly having an adjusting ring coupled to the disc bracket, wherein the adjusting ring is configured to rotate and adjust a position of the disc bracket and, consequently, the blade disc.

27. The grinder of claim 21, wherein the ion generator includes a plate having the pins extending therefrom, and wherein the plate extends at least partially across the channel.

28. A grinder appliance, comprising:
a body having a housing portion;
a grinding assembly positioned within the housing portion, wherein the grinding assembly is configured to grind whole beans into ground beans;
a chute extending between the grinding assembly and a discharge aperture; and
an ion generator extending through the chute and into a channel defined by the chute, wherein the ion generator includes:
an attachment feature configured to be coupled to at least one of the body and the chute;
at least one pin extending from an end of the attachment feature and into the channel; and
a power source coupled to the at least one pin to generate an ion field within the channel to reduce a charge on the ground beans traveling through the chute.

29. The grinder appliance of claim 28, wherein a width of a receiving end of the chute is less than a width of a dispensing end of the chute.

30. The grinder appliance of claim 28, wherein the at least one pin extends into the channel proximate to the dispensing end of the chute.

31. The grinder appliance of claim 28, further comprising:
a receptacle configured to receive the ground beans from the discharge aperture.

32. The grinder appliance of claim 28, wherein the at least one pin includes a first pin spaced from a second pin.

33. The grinder appliance of claim 32, wherein the first pin is horizontally aligned with the second pin.

34. The grinder appliance of claim 28, wherein the at least one pin has a proximal end having a width greater than a width of a distal end disposed within the channel.

35. The grinder appliance of claim 28, wherein a front of the chute has a shallower curve than a rear of the chute, and wherein the at least one pin extends through the rear of the chute.

36. A countertop appliance, comprising:
a body including a housing portion defining a discharge aperture and a dispensing opening;
a hopper coupled to the housing portion;
a grinder at least partially disposed within the housing portion, wherein the grinder is aligned with the discharge aperture of the housing portion, and wherein the grinder includes:
a grinding assembly;
a chute extending between the grinding assembly and the discharge aperture; and
an ion generator extending partially into a channel defined by the chute and configured to generate an ion field within the channel, wherein charged grounds are discharged from the grinding assembly and non-charged particles are discharged from the grinder; and
a brew system disposed at least partially in the housing portion and aligned with the dispensing opening.

37. The countertop appliance of claim 36, wherein the grinding assembly includes a blade disc and a taper blade, and wherein a space between the blade disc and the taper blade is adjustable to determine a size of the charged grounds.

38. The countertop appliance of claim 36, wherein the ion generator includes a plate with pins extending from the plate, and wherein the plate extends at least partially across the channel.

39. The countertop appliance of claim 36, wherein the ion generator includes pins that extend vertically within the channel defined by the chute.

40. The countertop appliance of claim 36, wherein the chute defines a first curve in a first direction and a second curve in a second direction, and wherein the ion generator extends through the chute between the first curve and the second curve.
